(19) United States
(12) Patent Application Publication
(10) Pub. No.: US 2003/0067954 A1
(43) Pub. Date: Apr. 10, 2003

(54) PHASE-CONJUGATION LASER MIRROR WITH FOUR-WAVE MIXING

(76) Inventor: MICHEL OUHAYOUN, PARIS (FR)

Correspondence Address: EUGENE C. RZUCIDLO, GREENBERG TRAURIG, LLP, 885 THIRD AVENUE 22TH FLOOR, NEW YORK, NY, 10022, US

(21) Appl. No.: 09/446,354

(22) PCT Filed: Jun. 16, 1998
(86) PCT No.: PCT/FR98/01257

(30) Foreign Application Priority Data
Jun. 17, 1997 (FR) 97 07483

(51) Int. Cl. H01S 3/08

(52) U.S. Cl. 372/102

(57) ABSTRACT

Laser with a phase-conjugate mirror by a four-wave interaction in its amplifying medium (2), in which the said mirror (9) is generated by exclusively passive means (5-8). A single amplifying medium (2) is provided in a Fabry-Pérot cavity and the said passive means (5-8) are designed to generate pumping beams forming a standing wave in the said cavity.

The laser is well suited to the machining of materials.

A laser beam, which, after having passed through an inhomogeneous medium a first time, has undergone a phase distortion, recovers its initial profile after being reflected off a phase-conjugate mirror and passing back through the same medium again.

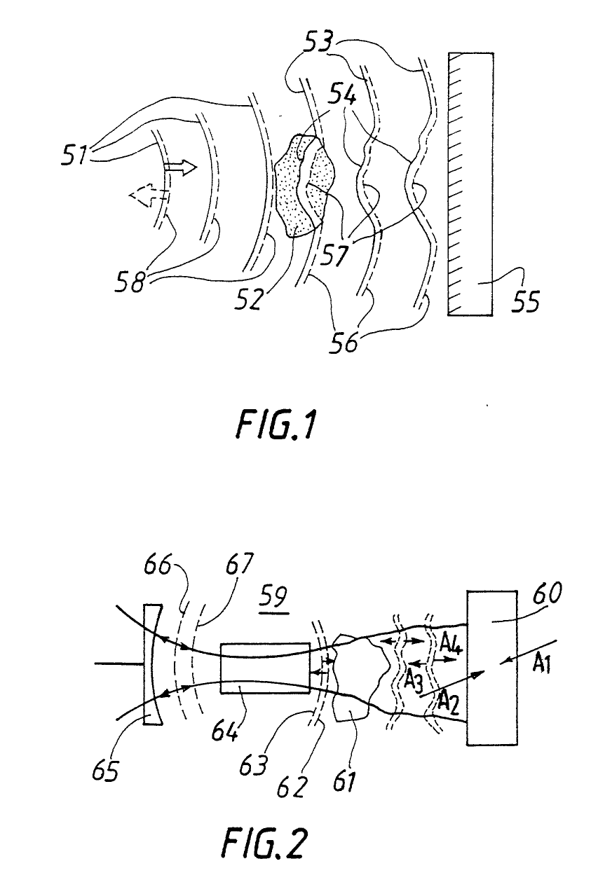

Referring to FIG. 1 appended hereto, the pure incident wave 51, after passing through the medium 52, becomes a wave 53 which includes a phase-retarded portion 54. After reflection off the phase-conjugate mirror 55, the wave 53 becomes a reflected wave 56 with a phase-advanced portion 57. This wave 56, after passing through the medium 52, which here is a phase retarder, becomes a pure reflected wave 58.

Referring to FIG. 2, a phase-conjugate mirror 60 placed at one end of a laser cavity 59, opposite an output mirror 65 at the other end, corrects, in real time, by four-wave interaction, the beam distortions for which the gain medium 64 may be responsible and which are schematically illustrated by the medium 61.

After distortion in the medium 61, the incident wave A4 impinging on the mirror 60 is reflected as a wave A3 which, after passing through the medium 61, becomes a wave 62 having the same profile as the initial wave 63.

The laser beam which exits via the mirror 65, and whatever the number of reflections undergone, has necessarily, just before exiting, passed through the distortion medium 61 twice, in opposite directions, with intermediate reflection off the mirror 60 so that it exits with a pure profile as illustrated by the waves 66, 67. By virtue of the mirror 60, any cumulative distortion effect is avoided.

A phase-conjugate mirror, as perfectly taught by U.S. Pat. No. 4,233,571, comprises a non-linear medium pumped by two beams and, advantageously, its non-linear medium is the amplifying medium of the laser resonator itself. In this case, the resonator comprises only a single conventional reflecting mirror serving both as output mirror and as means for creating, by reflection, one of the two pumping beams of the phase-conjugate mirror.

Four-wave interaction phase-conjugate mirrors provide a good solution to the problem of the emission of continuous or pulsed, solid-state or gas laser resonators in a single transverse mode, a priori the lowest-order fundamental mode (TEM₀₀), with the smallest possible beam divergence and the highest possible beam intensity as may be desired in power lasers, for example those used for the machining of materials, these mirrors, as mentioned above, fully overcoming the defects in homogeneity of lasing media.

In flashlamp-pumped solid-state lasers, the heat dissipation in the rod, as a result of the absorption of the flashlamp light not converted into coherent energy, introduces a thermal lens effect which results in the lasing rod behaving as a lens, the equivalent focal length of which depends on the heating undergone, thereby impairing the stability of the emitted mode. The radial non-uniformity of the refractive index in the lasing medium is also the cause of a birefringence effect which results in losses in the case of the fundamental mode.

In gas lasers, the hot spots in the discharge break the gain uniformity and index uniformity of the amplifying medium.

Laser resonators with a four-wave interaction phase-conjugate mirror have already been proposed, but with external pumping, such as, for example, in U.S. Pat. No. 4,233,571 and European Patent 0,190,515. These devices of the prior art make use of a second pumping laser, that is to say active means, in order to create the phase-conjugate mirror.

The present invention aims to dispense with this pumping laser for the phase-conjugate mirror.

For this purpose, the present invention relates firstly to a laser with a phase-conjugate mirror by a four-wave interaction in its amplifying medium, characterized in that the said mirror is generated by exclusively passive means.

The expression by exclusively passive means should be understood to mean means that do not generate photons.

In the preferred embodiments of the laser of the invention, a single amplifying medium is provided in a Fabry-Pérot cavity and the said passive means are designed to generate pumping beams forming a standing wave in the said cavity.

Advantageously, the said passive means comprise, at the two ends of the cavity, mirrors for creating two X-crossed beams with a central intersection region forming a mirror, each beam extending between a cavity-end mirror, at one end of the cavity, and a folding mirror, at the other end of the cavity, each beam forming a grating in the lasing medium off which is reflected, with phase conjugation, a probe wave of the other beam propagating from an end mirror towards the central mirror region.

Finally, in this embodiment, the invention is noteworthy for its simplicity. The laser of the invention corresponds schematically to a conventional laser folded on itself and crossed.

In another embodiment of the laser of the invention, with a Fabry-Pérot cavity and a pumped-phase conjugate mirror in its actual cavity, the phase-conjugate mirror is created by interference between linearly polarized waves propagating in opposite directions and reflected off this mirror, with phase conjugation, is an incident probe wave of orthogonal linear polarization.

In this case, the Fabry-Pérot cavity may be provided with, on either side of the amplifying medium and internal to the two cavity-end mirrors, a quarter-wave plate, on one side, and a Glan prism associated with a reflecting mirror, on the other side.

However, this embodiment with crossed-polarized probe and pump waves remains just as flexible as the previous embodiment by virtue of its geometry, which is no longer in the form of an X but is aligned.

In yet another embodiment of the laser of the invention with a Fabry-Pérot cavity, the phase-conjugate mirror is pumped outside its actual cavity.

In this case, a second Fabry-Pérot cavity may be placed off-axis with respect to the first in order to create the phase-conjugate mirror, advantageously by a Glan prism for extracting a weak wave with a polarization orthogonal to that of the optical standing wave generated by the stimulated emission in the first cavity, the Glan prism being associated with a mirror external to the first cavity.

Finally, in all its embodiments, the laser of the invention is quite a simple laser or an improved conventional laser with a Fabry-Pérot cavity.

This is why the Applicant also intends to claim a method of improving, or renovating, a conventional laser with an amplifying medium in a cavity defined by cavity-end mirrors, characterized in that it is converted into a laser according to the invention.

In a first particular mode of implementing the method, the cavity-end mirrors are replaced, on one side of the amplifying medium, with a pair of folding mirrors and, on the other side, with a pair of two end mirrors of a conventional Fabry-Pérot cavity.

In another mode of implementing the method, inserted between the amplifying medium and the cavity-end mirrors are, on one side, a quarter-wave plate or a Fresnel prism and, on the other side, a combination of a Glan prism and a mirror.

In yet another different mode of implementing the method, a Glan prism is inserted, on both sides, between the amplifying medium and the cavity-end mirrors, both the latter being totally reflecting.

The invention will be more clearly understood with the aid of the following description of several embodiments of the laser of the invention, with reference to the appended drawing in which:

FIG. 1 illustrates the effect on a wave of the reflection between two passes through a phase-retarding medium;

FIG. 2 illustrates the effect of FIG. 1 applied to a laser cavity;

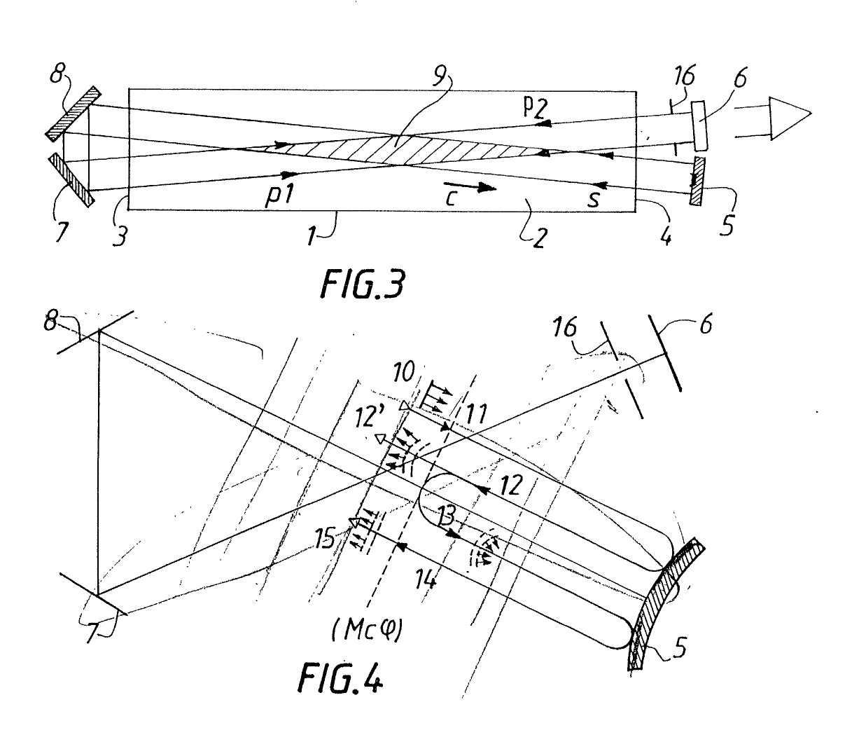

FIG. 3 shows a first embodiment of the laser of the invention, with a phase-conjugate mirror, intracavity pumping and X geometry;

FIG. 4 is a schematic representation on an enlarged scale of the laser in FIG. 3, for analysing a particular beam;

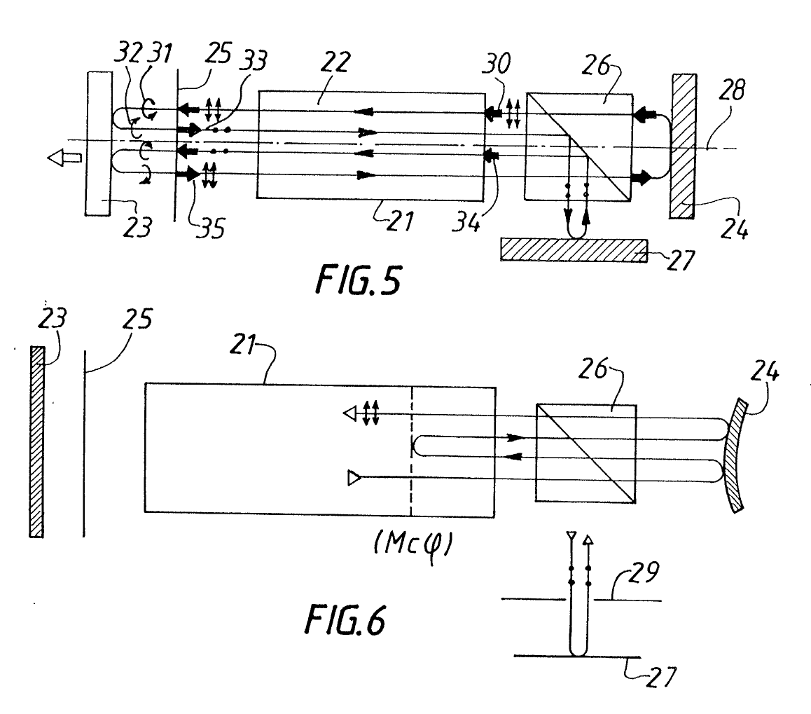

FIG. 5 shows a second embodiment of the laser of the invention, with a phase-conjugate mirror, intracavity pumping and aligned geometry with cross polarizations;

FIG. 6 is a schematic representation on an enlarged scale of the laser in FIG. 5, for analysing a particular beam;

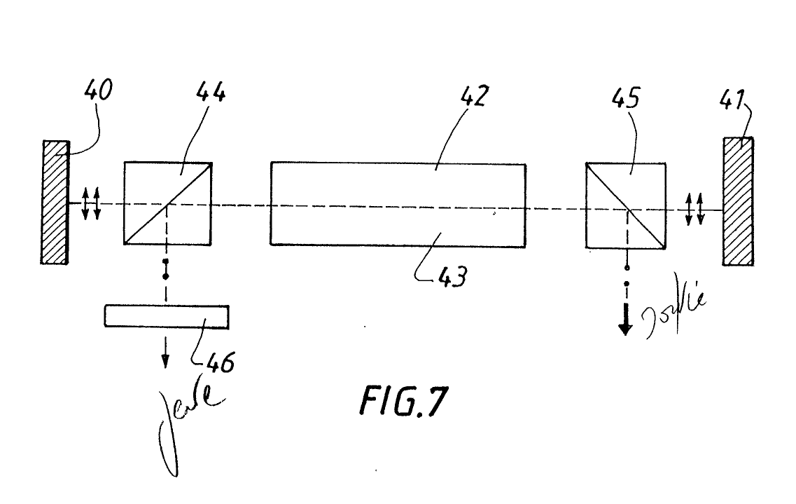

FIG. 7 shows a third embodiment of the laser of the invention, with a phase-conjugate mirror and extracavity pumping.

Referring to FIG. 3, the Fabry-Pérot laser resonator comprises a cavity 1 containing an amplifying medium 2 with, at its two ends 3, 4, windows (not shown) through which laser beams pass, the cavity 1 being placed between two cavity-end mirrors 5, 6, on one side, and two folding end mirrors 7, 8, on the other side. It will be noted that the folding end mirrors are not cavity-end mirrors. The end which is refered to must be regarded as a structural and not an optical notion, the cavity extending from one of the two mirrors 5, 6 to the other. The mirrors 7, 8 are not intracavity mirrors.

The mirror 6 serves as the extraction mirror. The other three mirrors are totally reflecting mirrors. The four mirrors are inclined so that the two mirrors 7, 8 fulfil their folding function and the laser waves, inside the cavity, propagate along the beams forming two bars in an X configuration, with an intersection region 9 approximately at the centre of the cavity.

Two waves, for example p1 and p2, propagate in opposite directions along each bar of the X and form a grating in the lasing medium with respect to a wave S which propagates in one half of the other bar towards the intersection region 9, before being reflected as the wave C by four-wave interaction with phase conjugation. The same applies, conversely, for the waves in the other arm of the X.

The efficiency of the interaction depends on the non-linearity of the gain and on the intensities of the waves. It is known that the intensities are high in a high-gain medium, as is the case in power lasers (excimer, neodymium:YAG, CO₂, etc.).

Furthermore, and with reference to FIG. 4 which does not strictly correspond to FIG. 3, because of the dissymmetry introduced the convexity of the mirror 5 which omits the contribution of the grating extending along the bar on which the mirror 5 is specifically located, analysis shows that, for each beam 10 which comes back on itself 15 after non-linear reflection 12 off the phase-conjugated mirror 9 shown symbolically here by one of its infinity of planes M_{cφ}, preceded 12 and followed 14 by reflection off a cavity-end mirror 5, there is compensation for the phase shifts undergone, unlike the beam 12 which undergoes a single reflection off the cavity-end mirror 5. A phase angle, for example the convex curvature of the mirror 5, makes it possible to produce the difference between the beams 15 and 12. The divergent beam 12 can then be removed by an aperture stop 16 before extraction via the mirror 6.

The propagation phase-shift correction also means that, as in any resonator with a four-wave interaction phase-conjugate mirror tuning of the cavity takes place whatever its length.

Referring to FIG. 5, the Fabry-Pérot resonator, in this case with an aligned geometry, comprises, between two cavity-end mirrors 23, 24, a cavity 21 containing an amplifying medium 22 and, between the cavity 21 and each cavity-end mirror, on one side, a quarter-wave (λ/4) plate 25 and, on the other side, a Glan prism 26 associated with a mirror 27. A Glan prism transmits a vertically polarized incident beam and reflects a horizontally polarized incident beam. Extraction takes place here via the mirror 23.

In aligned geometry, the distinction between the pump and probe waves, i.e. those forming the gain grating and that reflected off the latter, which distinction was imposed in the embodiment in FIGS. 3 and 4 by the X configuration, results here from the choice of the crossed polarizations.

For the sake of clarity in FIGS. 5 and 6, the beam after reflection has been artificially shifted. To begin with, consider a wave 30, linearly polarized in the vertical plane, on the same side as the Glan prism 26, entering the amplifying medium 22. After the wave passes through the λ/4 plate 25, the axes of which are inclined at 45° to the optical axis 28 of the laser, the polarization is circular 31, reversed 32 after reflection off the mirror 23 and then linear 33 after passing through the plate 25 again. After the wave 33 has passed through the gain medium 22, it is reflected by the Glan prism 26 onto the mirror 27, which sends back a wave 34 into the cell 21. After again following the plate 25—mirror 23—plate 25 path, the emergent wave 35, of vertical linear polarization, merges with the wave 30 after amplification, passage through the prism 26 in both directions and reflection off the mirror 24, the condition for standing waves thus being fulfilled.

The four passes through the gain medium 22 create two gratings, associated with the interference between waves propagating in opposite directions with a horizontal linear polarization, namely waves 33, 34, or with a vertical linear polarization, namely waves 30, 35, each incident wave, of orthogonal polarization, being reflected off the gratings with phase conjugation.

As in the X geometry of FIG. 4, and with reference to FIG. 6, a phase angle—convex mirror 24 associated with an aperture stop 29 placed in front of the mirror 27—favours oscillation of the resonator with a mirror for the desired phase conjugation.

The λ/4 plate 25 may be replaced with a Fresnel prism, for better optical flux behaviour, or with an equivalent mirror.

With reference to FIG. 7, the Fabry-Pérot resonator comprises, between two totally reflecting cavity-end mirrors 40, 41, a cavity 42 containing an amplifying medium 43 and, on both sides of the cavity 42, between the cavity and the mirrors, two Glan prisms 44, 45, one 44 being associated with a mirror 46. In this resonator, the phase-conjugate mirror, subjected to pumping from outside its actual cavity, is created by a second, off-axis, Fabry-Pérot cavity as will now be explained.

The Glan prisms 44 and 45, placed at each end of the amplifying medium 43, split the reflected, horizontally polarized and transmitted, vertically polarized beams which participate in two separate Fabry-Pérot resonators.

When the amplifying medium 43 is excited, a vertically polarized optical standing wave grows by stimulated emission in the low-loss Fabry-Pérot resonator bounded by the two mirrors 40 and 41, in which resonator it forms a grating in the gain medium 43. Its power would reach the saturation power if the residual birefringencies, in the amplifying medium 43 and in the prism 44, as well as the effects of scattering, were not to give rise to a weak, horizontally polarized, wave.

This weak wave, extracted by the Glan prism 44, reflected by the mirror 46 and then amplified and diffracted by the grating of the gain medium 43, initiates the oscillation of the Fabry-Pérot resonator with a phase-conjugate mirror 46, 43. In this case, the reflection region and the pumped non-linear region are coincident. The non-linear medium 43 of the mirror is pumped by the two beams, vertically polarized in opposite directions, coming from outside its cavity 46, 43. The beam is extracted by reflection off the prism 45 or, better still, through the mirror 46 so as to optimize the wavefront correction effect.

Mode selection is provided either by an aperture stop placed in front of the mirror 46 or by the mirror 46 itself if this is a Gaussian mirror.

If the reflection coefficient of the phase-conjugate mirror is not high enough, a booster amplifier, in this case a cavity similar to the cavity 42, may be provided between the Glan prism 44 and the mirror 46 in order to give rise to stimulated emission therein, the amplifying cavity being excited synchronously with the cavity 42. It is also possible to provide, between the amplifier and the mirror 46, a multimode hollow guide or optical fibre for flexible supply of coherent light to the station where the laser is used. It is also possible to use an amplifying fibre, for example a neodymium-doped fibre. A doubling device may also be placed between the prism 44 and the mirror 46, essentially to double the frequency.

Having described the various embodiments of the laser of the invention, the process for renovating conventional lasers will now be mentioned. This renovation, involving conversion, is of the most simple kind since the cavity containing the amplifying medium is not touched. All that is required to be done is to make the necessary substitution of the original cavity mirrors with mirrors, quarter-wave plate and Glan prisms.

1. Laser with a phase-conjugate mirror by a four-wave interaction in its amplifying medium (2; 22), the said mirror (9; 22) being generated by exclusively passive means (5-8; 23-27), characterized in that the amplifying medium is placed in a single Fabry-Pérot cavity formed between the said phase-conjugate mirror and a solid mirror.

2. Laser according to claim 1, in which the phase-conjugate mirror (9; 22) is subjected to intracavity pumping.

3. Laser according to claim 2, in which the said passive means comprise, at the two ends of the cavity, mirrors for creating two X-crossed beams with a central intersection region (9) forming a mirror.

4. Laser according to claim 3, in which each beam extends between a cavity-end mirror (5, 6), at one end of the cavity, and a folding mirror (7, 8) at the other end of the cavity, each beam forming a grating in the lasing medium (2, 9), off which is reflected, with phase conjugation, a probe wave of the other beam, propagating from an end mirror (5-8) towards the central mirror region (9).

5. Laser according to either of claims 3 and 4, in which at least one (5) of the mirrors is a curved mirror and it is provided with a mode-selection aperture stop (16).

6. Laser according to claim 2, in which the phase-conjugate mirror is created by interference between linearly polarized waves (30, 35; 33, 34) propagating in opposite directions and reflected off this mirror, with phase conjugation, is an incident probe wave of orthogonal linear polarization.

7. Laser according to claim 6, in which the Fabry-Pérot cavity is provided with, on either side of the amplifying medium (22) and internal to the two cavity-end mirrors (23, 24), a quarter-wave plate (25), on one side, and a Glan prism associated with a reflecting mirror (27), on the other side.

8. Laser according to claim 7, in which at least one (24) of the cavity-end mirrors is a curved mirror and it is provided with a mode-selection aperture stop (29).

9. Laser according to claim 6, in which the cavity (21) for the amplifying medium is surrounded, on one side, by a Fresnel prism and, on the other side, by a Glan prism (26) associated with a mirror (27).

10. Laser according to claim 1, in which the phase-conjugate mirror (43) is subjected to extracavity pumping.

11. Laser according to claim 10, in which a second Fabry-Pérot cavity (46, 44, 43) is placed off-axis with respect to the first cavity (40, 43, 41) in order to create the phase-conjugate mirror (43).

12. Laser according to claim 11, in which a Glan prism (44) is provided for extracting a weak wave with a polarization orthogonal to that of the optical standing wave generated by the stimulated emission in the first cavity, the Glan prism being associated with a mirror (46) external to the first cavity.

13. Laser according to either of claims 11 and 12, in which a booster amplifier is provided in the cavity (46, 44, 43) of the phase-conjugate mirror.

14. Laser according to claim 13, in which the booster amplifier is associated with an optical fibre.

15. Method of renovating a conventional optical laser with an amplifying medium in a cavity defined by cavity-end mirrors, characterized in that it is converted into a laser according to one of claims 1 to 14.

16. Method according to claim 15, in which the cavity-end mirrors are replaced, on one side of the amplifying medium, with a pair of folding mirrors and, on the other side, with a pair of two end mirrors of a conventional Fabry-Pérot cavity.

17. Method according to claim 15, in which, inserted between the amplifying medium and the cavity-end mirrors, are, on one side, a quarter-wave plate or a Fresnel prism and, on the other side, a combination of a Glan prism and a mirror.

18. Method according to claim 15, in which a Glan prism is inserted, on both sides, between the amplifying medium and the cavity-end mirrors, the latter both being totally reflecting.
